(19) United States
(12) Patent Application Publication
(10) Pub. No.: US 2002/0050198 A1
(43) Pub. Date: May 2, 2002

(54) Slicing machine with high-accuracy slice thickness

(76) Inventor: Fritz Kuchler, Klagenfurt (AT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/012,822

(22) Filed: Oct. 30, 2001

(30) Foreign Application Priority Data
Oct. 31, 2000 (AT) A1844/2000

(51) Int. Cl. B26D 5/20; B26D 7/06

(52) U.S. Cl. 83/76.8; 83/932; 83/717

(57) ABSTRACT

A slicing machine has a blade, a stop plate extending parallel to the blade, and a carriage adapted to hold a sliceable product against the plate and displaceable past the blade to cut a slice from the product. A large-diameter disk is rotatable about an axis substantially parallel to the blade and is formed with a spiral groove. A follower coupled to the stop plate is engaged in the groove. A drive motor rotates the disk to displace the stop plate parallel to the blade axis. A small-diameter sensor wheel is positively coupled by a nonsmooth drive element to the disk. A sensor determines the angular position and rotation of the disk and generates an actual-value output corresponding thereto. A desired-value signal corresponding to a desired slice thickness is fed to a controller connected to the sensor and to the motor to make the output equal to the desired-value signal.

### FIELD OF THE INVENTION

The present invention relates to a slicing machine. More particularly this invention concerns a foodstuff slicing machine with variable slice thickness.

### BACKGROUND OF THE INVENTION

A standard slicing machine has an input table that can be reciprocated longitudinally past a normally circular rotating blade to cut slices from a foodstuff, for instance a piece of meat or cheese, sitting on the input table. On the other side of the blade the slices are picked up by a conveyor, typically a fork-, belt-, or chain-type arrangement having a support plate and provided with a multiplicity of sharp points so that the slices can be caught as they issue from the downstream side of the blade. The slices are then deposited on an output table which is positioned horizontal underneath the downstream side of the blade. Thus as the input table is moved back and forth, slices are cut from the foodstuff thereon, these slices pass the blade and are picked up the conveyor, and the transfer fork deposits them in a stack on the output table, which itself can shift horizontally to array the incoming slices. Such machines are described in detail in my earlier U.S. Pat. No. 4,185,527, 4,217,650, 4,338,836, 4,379,416, 4,586,409, 4,598,618, 4,763,738, and 4,867,257.

This type of slicing machine is used in a commercial operation to produce marketable quantities of different cold cuts, e.g. meats and cheeses. The cold cuts need to be sliced to different thicknesses with hard foodstuffs like salami cut very thin and soft ones like liverwurst much thicker. It is standard marketing practice to produce batches of slices that add up to an exact weight, e.g. 100 g, so that the thus sliced product can be put out and the purchaser can simply scoop up the desired number of batches. In this manner each order does not have to be custom cut while the customer waits.

In order to set slice thickness, German 3,304,610 describes how a stop plate is arranged extending parallel to the plane of the blade but movable on the machine base on guides extending perpendicular to this plane. A large-diameter setting disk lying in a plane perpendicular to the plane and offset therefrom is rotatable about an axis parallel to the plane and formed on one face with a spiral guide groove in which engages a follower coupled directly to the stop plate. A motor can rotate the setting disk to adjust the position of the stop plate and thereby set the slice thickness. This simple drive system allows the carriage, which can be a single piece cast unitarily with the follower arm, easy to remove and clean. According to Austrian 396,665 the stop plate is always returned, when the blade is arrested, to a position with its face coplanar with the blade to in effect shield the blade edge and prevent accidents.

German 195 94 385 describes a digital system for setting the slice thickness. To this end a slide potentiometer is coupled directly to the stop plate so that it produces an analog resistance output that is directly proportional to the position of the setting plate. Such a system is relatively crude, in particular as slice thickness must often be adjusted very finely, in particular in setups where the machine is to produce individual uniform-weight batches.

In European 1,022,102 the slicing machine has a stop plate controlled by a special knob. This knob contains a switch system that can turn the cutting machine on and off, and also is of course operable to set slice thickness. Otherwise this machine is not capable of accurate slice-thickness setting, much less slice adjustment on the fly. In all the known machines the user must be acquainted with the inventory so as to know what to cut to what thickness and so on, making counter work even with such a machine a relatively specialized task requiring some training.

### OBJECTS OF THE INVENTION

It is therefore an object of the present invention to provide an improved slicing machine.

Another object is the provision of such an improved slicing machine which overcomes the above-given disadvantages, that is which can be set for a very exact slice thickness.

### SUMMARY OF THE INVENTION

A slicing machine has a housing, a blade rotatable on the housing about a blade axis, a stop plate extending substantially perpendicular to the axis and parallel to the blade on the housing and oriented adjacent the blade, and a carriage adapted to hold a sliceable product against the plate and displaceable transversely of the axis on the housing past the blade so that a slice of the product will be cut from the product as it is moved past the blade by the carriage. A large-diameter disk is rotatable about an axis substantially parallel to the blade and formed centered on the disk axis with a spiral groove. A follower coupled to the stop plate is engaged in the groove. A drive motor coupled to the disk rotates the disk and thereby displaces the stop plate parallel to the blade axis. According to the invention a small-diameter sensor wheel rotatable about a wheel axis generally parallel to and offset from the disk axis is positively coupled by a nonsmooth drive element to the disk for joint rotation. A sensor associated with the sensor wheel determines the angular position and rotation of same and generates an output corresponding to the determined angular position and rotation. An input device creates a desired-value signal corresponding to a desired slice thickness. A controller connected to the input device, sensor, and motor compares the output with the desired-value signal and operates the motor in the necessary direction to make the output equal to the desired-value signal.

The relative sizes of the disk and wheel ensure that even the tiniest displacement of the stop plate will be detected and the feedback system will even readjust blade position on the fly, that is when the machine is operating, if in the middle of a run it is determined that the slice thickness should be increased or decreased a bit. Thus it is possible to minutely control slice thickness, and to dynamically control it during the slicing operation.

According to the invention the nonsmooth element is a toothed belt. In addition the sensor can include a potentiometer connected to the sensor wheel in which case the actual-value output is a resistance. Alternately the sensor wheel has an annular array of angularly equispaced perforations and a photoelectric device aimed at the perforations detects same. In this latter case rotation of the wheel will cause the photoelectric device to emit a series of pulses that are simply counted to form the actual-value signal.

The input device includes a keyboard or keypad. It can also include a knob pivotal in two opposite directions and respective switches operable by the knob on rotation in the directions for displacement of the stop plate in respective opposite directions. The knob is coaxial with the motor and can hold a start switch for the slicing machine. It can be used simply like the standard mechanical systems to set slice thickness also, so that an experienced operator can set the machine manually, with a power assist so to speak. Thus the setting knob is in the position that is standard for a slicing machine, pointed to the front and not blocking view of or access to the foodstuff on the slicing carriage.

According to the invention the input device includes a display for showing the desired-value signal and/or the actual/value signal. It can also have means for calculating the desired-value signal based on product type. Thus the user can input the sales code for the product and the machine will automatically set the standardized slice thickness for this product. Of course this product-code information can also be employed to control how many pieces in a batch and how any output table should move to array them.

### BRIEF DESCRIPTION OF THE DRAWING

The above and other objects, features, and advantages will become more readily apparent from the following description, reference being made to the accompanying drawing in which:

FIG. 1 is a largely diagrammatic top view of the slicing machine according to the invention;

FIG. 2 is an end view of a detail of FIG. 1; and

FIG. 3 is a partly schematic detail view of a control knob of the machine.

### SPECIFIC DESCRIPTION

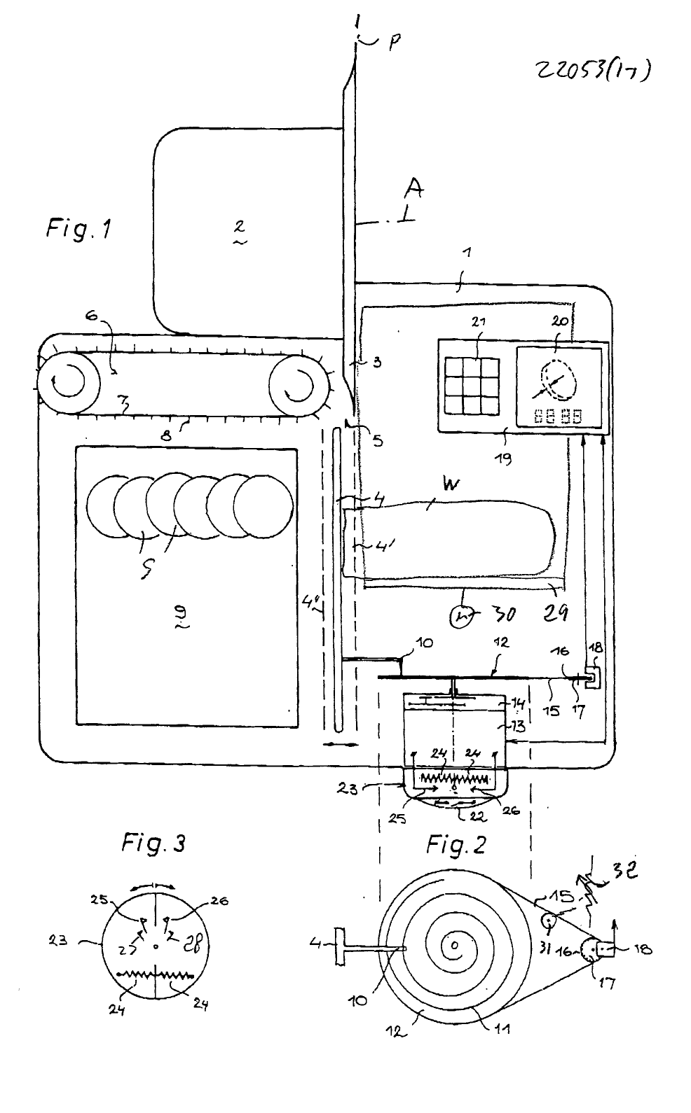

As seen in FIG. 1 a slicing machine according to the invention has a housing 1 on which a motor 2 can rotate a circular disk blade 2 about an axis A in a plane P. A planar stop plate 4 parallel to the plane P is movable in an unillustrated guide on the housing between an outermost position 4′ with its face on the plane P and an innermost position 4″ substantially offset from but still parallel to this plane P and forming a slicing gap 5 therewith. A foodstuff W to be sliced is held on a carriage or table 29 reciprocal by a motor 30 parallel to the plane P so as to cut a slice S off an end of the foodstuff W and pass it through the gap 5 to a handling device 6 having a chain 7 provided with points 8 and operated to take the incoming slices S and array them on a movable table 9. Thence the slices are packaged as, for instance, described in U.S. Pat. No. 6,279,302.

The stop plate 4 is displaced by a motor 13 which is fixed on the housing 1 and drives a large-diameter setting disk 12 via a step-down transmission 14. The disk 12 is provided as shown in FIG. 2 with a spiral groove 11 of uniform pitch in which is engaged a follower tip of an arm 10 of the plate 4. Its outer periphery is formed like a toothed-belt V-pulley. An unillustrated spring urges the arm 10 toward position 4′ into engagement with one flank of the spiral groove 11 so that the position of the plate 4 is determined wholly by the angular position of the disk 12. This is all substantially standard and described in detail in the above-cited patent literature.

In accordance with the invention a toothed belt 15 engaged around the large-diameter disk 12 is also looped over a small V-pulley wheel 31 connected to a multiturn potentiometer 32 and another such small wheel 17 formed with an annular array of angularly equispaced holes 16 detectable by a photoelectric device or light curtain 18. Thus as the disk 12 rotates the potentiometer 32 is displaced and its resistance changes, and at the same time the wheel 17 rotates so that the photoelectric device 18 sees a succession of blips. Both outputs are fed to a controller 19 having a display 20 and a keyboard input 21. Due to the substantial difference between the diameters of the disk 12 and the wheels 17 and 31, even a tiny displacement of the plate 4 will be detected and reported by the sensors constituted by the potentiometer 32 and light curtain 18.

In addition as shown in FIG. 3 the motor 13 is formed at its end with a coaxial knob 23 urged into a center position by a pair of springs 24 and movable to either side of this center position to actuate either of a pair of switches 25 and 26. The motor 13 is rotated to move the plate 4 at slow speed inward toward the position 4″ when the switch 25 is operated and at slow speed outward toward the position 4∝ when the switch 26 is tripped. Further switches 27 and 28 behind the switches 25 and 26 are operated by a more forceful turning of the knob 23 in the appropriate direction for similar movement but at a much higher speed. Thus for a small fine adjustment, for instance toward the position 4′ to decrease slice thickness, the knob 23 is rotated clockwise slightly to actuate the switch 26, but for faster movement toward this position it is twisted more forcefully to trip the switch 28, and vice versa. In addition the knob 23 incorporates a push-type on-off switch 22 which is pushed to start a slicing operation. This switch 22 can also function, during a slicing operation, as an emergency cutoff. Thus once the desired slice thickness, either by entering a code or dimension with the keyboard 21 or by twisting the knob 23 one way or the other, the knob 23 is bumped to actuate the switch 22. This causes the stop plate 4 to move from the rest or safety position 4∝ to the desired spacing, and the automated slicing operation can begin. Another bump on the knob 23 during the slicing operation will stop the machine.

The controller 19 includes a comparator that, once the switch 22 is briefly actuated, compares the actual-value signal received from the sensor 32 or 18 with a desired value received from the keyboard 21 or calculated based on input at this keyboard 21. More particularly it is possible for the keyboard 21 to be used to input a given slice thickness, which directly constitutes the set-point or desired-value signal. Alternately a code can be entered for the particular type of foodstuff and a memory in the controller 19 can call up the preferred slice thickness for this foodstuff. In addition the operator can use the knob 23 to adjust the slice thickness one way or the other so that this knob 23 also can provide input or set the desired-value signal corresponding to desired slice thickness, like the keyboard 21. Furthermore, in a more sophisticated system which weighs the slices as they are cut, the system can vary slice thickness to produce a batch of a predetermined weight. the product code can also control operation of the output table 9 to form different kinds of arrays of the slices S.

I claim:

1. A slicing machine comprising:
a housing;
a blade rotatable on the housing about a blade axis;
a stop plate extending substantially perpendicular to the axis and parallel to the blade on the housing and oriented adjacent the blade;
a carriage adapted to hold a sliceable product against the plate and displaceable transversely of the axis on the housing past the blade, whereby a slice of the product will be cut from the product as it is moved past the blade by the carriage;
a large-diameter disk rotatable about an axis substantially parallel to the blade and formed centered on the disk axis with a spiral groove;
a follower coupled to the stop plate and engaged in the groove;
drive means including a motor coupled to the disk for rotating the disk and thereby displacing the stop plate parallel to the blade axis;
a small-diameter sensor wheel rotatable about a wheel axis generally parallel to and offset from the disk axis;
a nonsmooth drive element engaged over the disk and the wheel and positively coupling same together for joint rotation;
sensor means associated with the sensor wheel for determining the angular position and rotation of same and generating an output corresponding to the determined angular position and rotation;
input means for creating a desired-value signal corresponding to a desired slice thickness; and
control means connected to the input and sensor means and to the motor for comparing the output with the desired-value signal and operating the motor so as to make the output equal to the desired-value signal.

2. The slicing machine defined in claim 1 wherein the nonsmooth element is a toothed belt.

3. The slicing machine defined in claim 1 wherein the sensor means includes a potentiometer connected to the sensor wheel, the actual-value output being a resistance.

4. The slicing machine defined in claim 1 wherein the sensor wheel has an annular array of angularly equispaced perforations, the sensor means further comprising a photoelectric device aimed at the perforations for detecting same.

5. The slicing machine defined in claim 1 wherein input means includes a keypad.

6. The slicing machine defined in claim 1 wherein the input means includes:
a knob pivotal in two opposite directions, and respective switches operable by the knob on rotation in the directions for displacement of the stop plate in respective opposite directions.

7. The slicing machine defined in claim 6 wherein the knob is coaxial with the motor.

8. The slicing machine defined in claim 6 wherein the knob includes a start switch for the slicing machine.

9. The slicing machine defined in claim 1 wherein the input means includes a display for showing the desired-value signal.

10. The slicing machine defined in claim 1 wherein the input means includes means for calculating the desired-value signal based on product type.
